(19) United States
(12) Patent Application Publication
(10) Pub. No.: US 2010/0162124 A1
(43) Pub. Date: Jun. 24, 2010

(54) Methods, Systems, And Computer Program Products For Presenting A Map In Correspondence With A Presented Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/339,701

(22) Filed: Dec. 19, 2008

(51) Int. Cl. G06F 3/14

(52) U.S. Cl. 715/733

(57) ABSTRACT

Methods and systems are described for presenting a map for presenting in correspondence with a presented resource. A first message is received from a resource provider including a presentable resource accessible via a uniform resource identifier (URI). Map information identifying a map associated with the presentable resource is also received. Location information identifying a location on the map corresponding to the resource is received. The presentable resource is presented in a browser and the identified map including a visual representation of the presentable resource at the identified location on the map is presented in a second presentation space of the browser. In another aspect, message information identifying a recipient of a presentable resource accessible via an URI is received. Map information identifying a map corresponding to the presentable resource is determined based on the message information. A message including the map information is generated and sent to the identified recipient.

### RELATED APPLICATIONS

This application is related to the following commonly owned U.S. Patent Applications, the entire disclosure of each being incorporated by reference herein:

application Ser. No. 11/962,285 (Attorney Docket No 1509/US) filed on Dec. 21, 2007, entitled “Methods And Systems For Sending Information To A Zone Included In An Internet Network”;

application Ser. No. 12/170,281 (Attorney Docket No 1522/US) filed on Jul. 10, 2008, entitled “Methods And Systems For Resolving A Geospatial Query Region To A Network Identifier”;

application Ser. No. 12/170,829 (Attorney Docket No 1523/US) filed on Jul. 10, 2008, entitled “Methods And Systems For Resolving Location Information To A Network Identifier”;

application Ser. No. 12/170,833 (Attorney Docket No 1524/US) filed on Jul. 10, 2008, entitled “Methods And Systems For Resolving A Query Region To A Network Identifier”;

application Ser. No. 12/328,036 (Attorney Docket No 1496/US) filed on Dec. 4, 2008, entitled “Methods, Systems, And Computer Program Products For Browsing Using A Geospatial Map Metaphor”;

application Ser. No. 12/328,038 (Attorney Docket No 1508/US) filed on Dec. 4, 2008, entitled “Methods, Systems, And Computer Program Products For Associating Resources Of A First Geospace With A Second Geospace”;

application Ser. No. 12/328,048 (Attorney Docket No 1515/US) filed on Dec. 4, 2008, entitled “Methods, Systems, And Computer Program Products For Harmonizing A Geospatial Domain Space With A Non-Geospatial Domain Space”;

application Ser. No. 12/328,055 (Attorney Docket No 1516/US) filed on Dec. 4, 2008, entitled “Methods, Systems, And Computer Program Products For Accessing A Resource Based On Metadata Associated With A Location On A Map”;

application Ser. No. 12/328,059 (Attorney Docket No 1527/US) filed on Dec. 4, 2008, entitled “Methods, Systems, And Computer Program Products For Determining A Network Identifier Of A Node Providing A Type Of Service For A Geospatial Region”;

application Ser. No. 12/328,063 (Attorney Docket No 1534/US) filed on Dec. 4, 2008, entitled “Methods, Systems, And Computer Program Products For Accessing A Resource Having A Network Address Associated With A Location On A Map”;

application Ser. No. ______ (Attorney Docket No 1528/US) filed on ______, entitled “Methods, Systems, And Computer Program Products For Maintaining Consistency Between Non-Geospatial And Geospatial Network Directory Systems”; and

application Ser. No. ______ (Attorney Docket No 1529/US) filed on ______, entitled “Methods, Systems, And Computer Program Products For Synchronizing Second Level Resources with First Level Resources Of A Multi-level Navigation History”.

### BACKGROUND

Current web browsers do not provide a user with a sense of location for easing navigation and for knowing a location of a resource browsed. Browsers take users from one page to another with no transition that relates the two pages. Some pages provide information that relates them to other pages using, for example, links labeled “back” and “next. This provides a sense of location only within a select group of web pages.

Many resource provider websites are quite large and difficult to navigate. General purpose maps can locate the site on a map, but are not very helpful for navigating the website.

### SUMMARY

Accordingly, there exists a need for methods, systems, and computer program products for presenting a map corresponding to a presented resource received from a resource provider.

Methods and systems are described for presenting map in correspondence with presenting a received resource. In one aspect, a first message is received from a resource provider including a presentable resource accessible via a uniform resource identifier (URI). Map information identifying a map associated with the presentable resource is received along with the first message. Location information identifying a location on the map corresponding to the presentable resource is received. The presentable resource is presented in a first presentation space of a browser and the identified map including a visual representation of the presentable resource at the identified location on the map is presented in a second presentation space of the browser.

In another aspect, a system for presenting a map in correspondence with presenting a received resource includes means for receiving from a resource provider a first message including a presentable resource accessible via a uniform resource identifier (URI). The system also includes means for receiving map information identifying a map associated with the presentable resource along with the first message including the presentable resource. The system also includes means for receiving location information identifying a location on the map corresponding to the presentable resource. The system also includes means for presenting the presentable resource in a first presentation space of a browser and means for presenting, in correspondence with presenting the presentable resource, in a second presentation space of the browser the identified map including a visual representation of the presentable resource at the identified location on the map.

In another aspect, a system for presenting a map in correspondence with presenting a received resource includes a content manager component configured to receive from a resource provider a first message including a presentable resource accessible via a uniform resource identifier (URI). The system also includes a map widget handler component configured to receive map information identifying a map associated with the presentable resource. The map information is received along with the first message including the presentable resource. The system also includes a navigation space handler component configured to receive location information identifying a location on the map corresponding to the presentable resource.

In another aspect, a computer readable medium embodying a computer program, executable by a machine, for presenting a map in correspondence with presenting a received resource is defined. The computer program includes executable instructions for receiving from a resource provider a first message including a presentable resource accessible via a uniform resource identifier (URI). The computer program also includes executable instructions for receiving map information identifying a map associated with the presentable resource along with the first message including the presentable resource. The computer program also includes executable instructions for receiving location information identifying a location on the map corresponding to the presentable resource. The computer program also includes executable instructions for presenting the presentable resource in a first presentation space of a browser. The computer program also includes executable instructions for presenting, in correspondence with presenting the presentable resource, in a second presentation space of the browser the identified map including a visual representation of the presentable resource at the identified location on the map.

In another aspect, message information identifying a recipient of a presentable resource accessible via a uniform resource identifier (URI) is received. Map information identifying a map corresponding to the presentable resource is determined based on the message information. A message including the map information is generated. The generated message is sent to the identified recipient for receiving the map information corresponding to the presentable resource.

In another aspect, a system for providing a map for presenting in correspondence with a presented resource includes means for for receiving message information identifying a recipient of a presentable resource accessible via a uniform resource identifier (URI). The system also includes means for determining based on the message information map information identifying a map corresponding to the presentable resource. The system also includes means for generating a message including the map information. The system also includes means for sending the generated message including the map information to the identified recipient for receiving the map information corresponding to the presentable resource.

In another aspect, a system for providing a map for presenting in correspondence with a presented resource includes a message router component configured to receive message information identifying a recipient of a presentable resource accessible via a uniform resource identifier (URI). The system also includes a map handler component configured to determine based on the message information map information identifying a map corresponding to the presentable resource. The system also includes a message generator component configured to generate a message including the map information. The message generator component is also configured to send the generated message including the map information to the identified recipient for receiving the map information corresponding to the presentable resource.

In another aspect, a computer readable medium embodying a computer program, executable by a machine, for presenting a map in correspondence with presenting a received resource is defined. The computer program includes executable instructions for receiving message information identifying a recipient of a presentable resource accessible via a uniform resource identifier (URI). The computer program also includes executable instructions for determining based on the message information map information identifying a map corresponding to the presentable resource. The computer program also includes executable instructions for generating a message including the map information and sending the generated message including the map information to the identified recipient for receiving the map information corresponding to the presentable resource.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a flow diagram illustrating a method for presenting a resource in correspondence with presenting a received resource according to an aspect of the subject matter described herein;

FIG. 2 is block a diagram illustrating an arrangement of components for presenting a map in correspondence with presenting a received resource according to another aspect of the subject matter described herein;

FIG. 3 is a block diagram illustrating an arrangement of components providing an execution environment configured for hosting the arrangement of components of FIG. 2;

FIG. 4 is a block diagram illustrating a network having a node hosting an execution environment corresponding to the environment of FIG. 3 for hosting the components of FIG. 2 communicating with a network directory service according to an aspect of the subject matter described herein;

FIG. 5 is an exemplary graphical user interface for a browser in accordance with the teachings herein;

FIG. 6 is an alternative graphical user interface for the browser;

FIG. 7 is a further alternative graphical user interface for the browser;

FIG. 8 is a ladder diagram illustrating exemplary message flows for receiving map information identifying a map associated with a presentable resource in a message in accordance with the teachings herein;

FIG. 9 is an alternative ladder diagram illustrating additional message flows;

FIG. 10 is a flow diagram illustrating a method for providing a map for presenting in correspondence with a presented resource according to another aspect of the subject matter described herein;

FIG. 11 is block a diagram illustrating an arrangement of components for providing a map for presenting in correspondence with a presented resource according to another aspect of the subject matter described herein;

FIG. 12 is a block diagram illustrating an arrangement of components providing an execution environment configured for hosting the arrangement of components of FIG. 11; and

FIG. 13 is a block diagram illustrating an alternative arrangement of components providing an execution environment configured for hosting the arrangement of components of FIG. 11.

### DETAILED DESCRIPTION

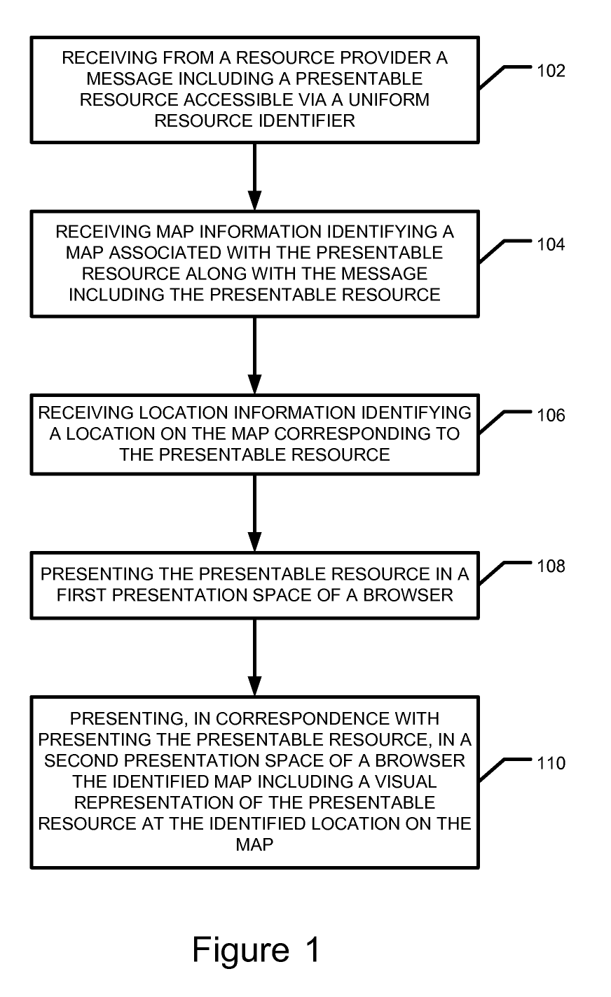

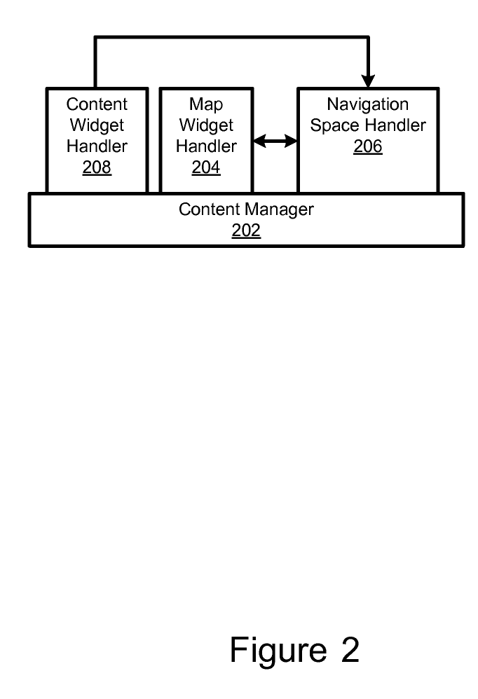

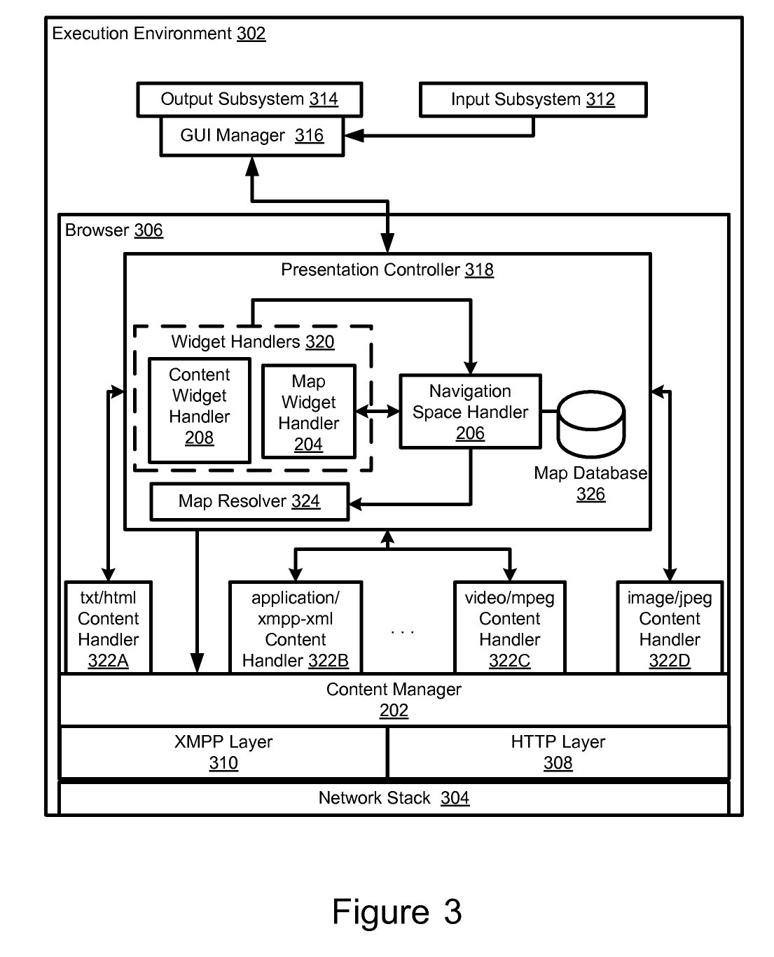

FIG. 1 is a flow diagram illustrating a method for presenting a map in correspondence with presenting a received resource according to an exemplary aspect of the subject matter described herein. FIG. 2 is a block diagram illustrating an arrangement of components for presenting a map in correspondence with presenting a received resource according to another exemplary aspect of the subject matter described herein. FIG. 3 is a block diagram illustrating an arrangement of components providing an execution environment configured for hosting the arrangement of components depicted in FIG. 2. The method illustrated in FIG. 1 can be carried out by, for example, some or all of the components illustrated in the exemplary arrangement in FIG. 2 operating in a compatible execution environment, such as the environment provided by some or all of the components of the arrangement in FIG. 3.

With reference to FIG. 1, in block 102 a first message including a presentable resource accessible via a uniform resource identifier (URI) is received from a resource provider. Accordingly, a system for presenting a map in correspondence with presenting a received resource includes means for receiving from a resource provider a first message including a presentable resource accessible via a URI.

For example, as illustrated in FIG. 2, a content manager component 202 is configured to receive a message including a presentable resource from a resource provider. The presentable resource is accessible via a uniform resource identifier (URI), such as a uniform resource locator (URL). The components depicted in FIG. 2 can be adapted for performing the method depicted in FIG. 1 in a number of execution environments, such as the exemplary execution environment 302 depicted in FIG. 3. Additionally or alternatively, an execution environment can be configured for hosting the components in FIG. 2 or analogous arrangements of components configured for performing the method in FIG. 1.

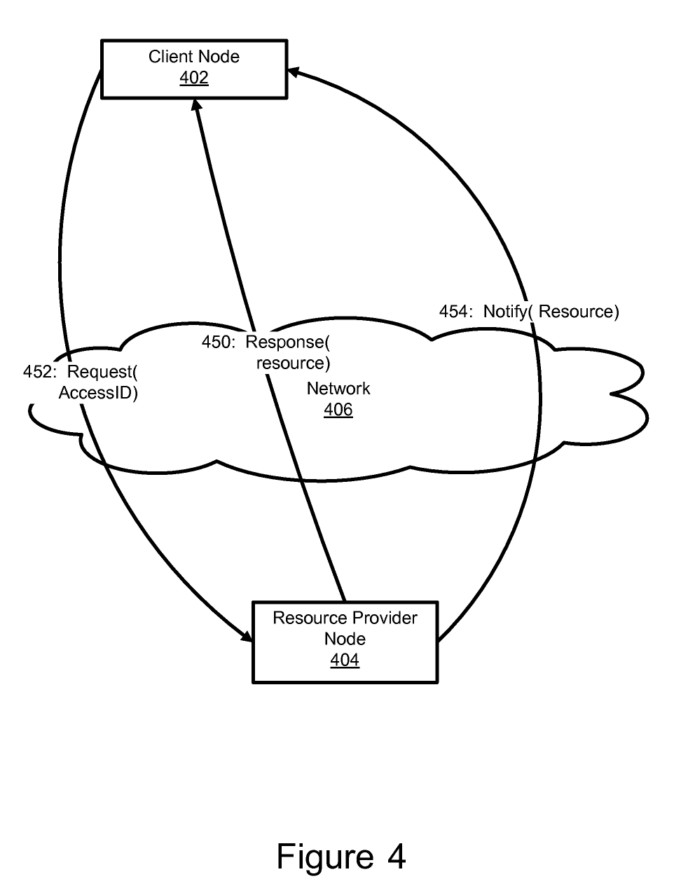

An execution environment can be hosted by a node and/or can be hosted by multiple nodes as in a distributed execution environment. In FIG. 4, a client node 402 can be configured to provide the execution environment 302 adapted for supporting the operation of the components in FIG. 2. An exemplary execution environment includes a memory for storing components and an instruction processing component, such as a processor and/or a digital signal processor (DSP), for processing instructions and any data associated with the operation of the components such as the components in FIG. 2. The components in FIG. 2 and functionally analogous arrangements of components each can require additional hardware and/or software subsystems according to their particular operational requirements. For example, a network subsystem, such as the network subsystem 304 in FIG. 3, can be included in the execution environment 302 for communicating with a component in a remote device, such as a second node, such as a resource provider node 404 over a network 406 as will be described below. An operating system, persistent data storage subsystem, memory management subsystem, and/or a process scheduler are other examples of components that can be required for various adaptations of the components in FIG. 2 and its functional analogs for performing the method illustrated in FIG. 1.

For example, as depicted in FIG. 3 the content manager component 202 is depicted as a component of a browser 306 operating in the execution environment 302. The response message 450 including a presentable resource identifiable by a URI can be received from a resource provider operating in an execution environment hosted by the resource provider node 404. Exemplary presentable resources include markup language base resources specified in an Extensible Markup Language (XML) variant and/or a Standardized General Markup Language (SGML) variant (e.g., Hypertext Markup Language (HTML)), media resources such as audio streams, video streams, and various forms of image and graphical data, plain text, and executable resources including scripts and applets.

URIs are defined by the World Wide Web Consortium (W3C) in RFC 3986 (“Uniform Resource Identifier (URI): Generic Syntax”, January 2005). URIs including a scheme modifier as described in U.S. application Ser. No. 11/615,438, titled “Method and Format for Specifying Scheme Parameters in a URL,” filed on Dec. 22, 2006 and U.S. application Ser. No. 11/957,809, titled “Methods and Systems for Accessing a Resource Based on URN Scheme Modifiers,” filed on Dec. 17, 2007, each of which is within the scope of the subject matter described herein and is hereby incorporated by reference in its entirety.

The response message 450 can be transmitted from the resource provider node 404 over the network 406 and received by the content manager component 202 via the network stack 304 operatively coupled to the network 406. The response message 450 can be formatted according to a request-response protocol. The resource provider node 404 can transmit the response message 450, in response to receiving a request message 452 including an access identifier for accessing the presentable resource. An HTTP layer 308 is depicted in FIG. 3 as an exemplary application protocol supporting a request-response model of communication.

Alternatively or additionally, the content manager component 202 can be configured to receive an asynchronous message including and/or referencing a presentable resource. FIG. 4 depicts a notify message 454 including a presentable resource transmitted from the resource provider node 404 via the network 406 and network stack 304 for receiving the presentable resource by the content manager component 202 operating in the client node 402. Any asynchronous protocol supported by a content manager and its hosting execution environment can be any suitable protocol including event notification protocols including tuple-base publish-subscribe with identifiable publishers and subscribes. Exemplary publish-subscribe protocols include presence protocols and the Jabber Foundation's publish-subscribe protocol as specified in XEP-060. The requirements and model for presence protocols including a publish-subscribe protocol are defined in RFC 2778 and RFC 2779. Exemplary publish-subscribe protocols that are also presence protocols include the presence protocol of the Extensible Message and Presence Protocol: Instant Messaging (XMPP-IM) specified in RFC 3921 and the Session Initiation Protocol (SIP) for Instant Messaging and Presence Leveraging Extension (SIMPLE), SIP/SIMPLE specified in RFC 3428.

FIG. 3 depicts an XMPP layer 310 as an exemplary application layer protocol supporting both the sending and receiving of asynchronous messages over XMPP. XMPP carries a notify message as defined by RFC 2778 & RFC 2779 included in a presence protocol (see XMPP-IM RFC 3921). The instant message protocol defines an instant message for sending and receiving as an asynchronous message and can include a presentable resource identified by a URI. Further, XEP-060 specifies a tuple-based publish-subscribe protocol, using XMPP as a transport protocol, supporting establishing a subscription to a tuple by a client. As a result of establishing the subscription, the client receives an asynchronous notification when the tuple subscribed to changes, for example as a result of a publish message identifying at least a portion of the tuple. The notify message 454 can represent any of these exemplary asynchronous messages. The request message 452 can represent a subscribe message or a publish message.

A request message such as an HTTP request, a subscription request, a publish request and/or an asynchronous message such as a publish message sent as an asynchronous message can be sent in response to an input received via an input subsystem 312 supporting an input device such as a pointing device, keyboard, and/or key pad. The input, as is typical, can be received in correspondence with a user interface widget presented on a display (not shown) via an output subsystem 314 including, for example, a display driver for an external display or an internal display. The user interface widget is provided by a GUI manager 316 or an analogous user interface component or subsystem.

An application, such as the browser 306 can direct the GUI manager 316 to present a particular widget type on a display via the output subsystem 314 by providing a widget handler component compatible with the widget type. FIG. 3 depicts a presentation controller component 318 configured to provide a plurality of widget handler components 320 for providing a user interface for the browser 306.

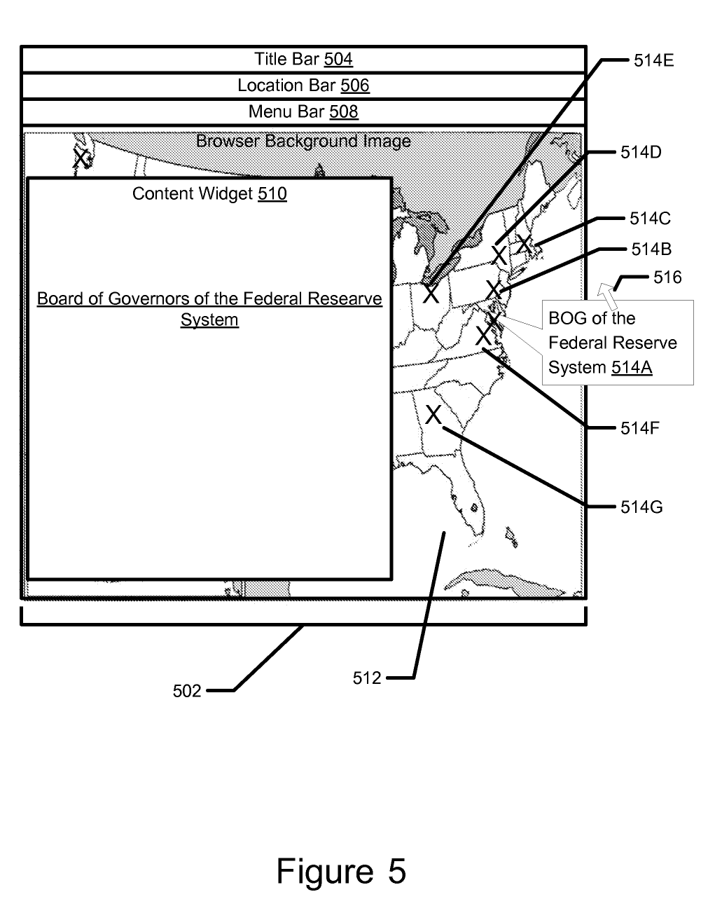

FIG. 5 depicts an exemplary user interface for the browser 306. The browser 306 can include a widget handler component 320 for presenting a browser window widget 502. In FIG. 5, the browser window widget 502 provides a presentation space for a title bar widget 504, and a location bar widget 506, a menu bar widget 508, as well as other widgets typically supported by browsers (not shown). The browser window widget 502 may depict one or more map marks 514, “X's” indicating locations associated with resources and/or resource providers. A map mark 514, “X”, may be associated with a flyover text widget identifying a resource such as a resource provider. For example, flyover text widget identifies the map mark 514A representing a resource/resource provider as the Board of Governors of the Federal Reserve located in Washington, DC. An arrow icon 516 is presented as a visual indicator over a flyover text associated with the map mark 514A. The browser window widget 502 also includes a content widget 510 for presenting a presentable resource from a resource provider such as the Board of Governors of the Federal Reserve located in Washington, DC as illustrated.

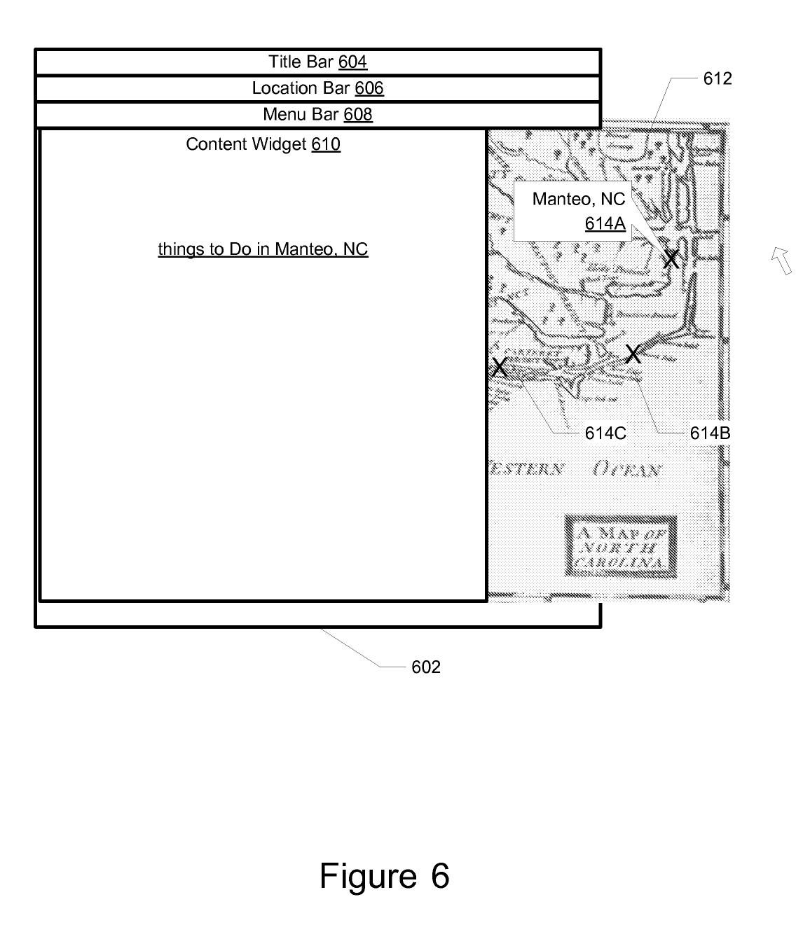

FIG. 6 depicts an alternative user interface for the browser 306. The browser 306 can include a widget handler component 320 for a browser window widget 602. The browser window widget 602 can provide a presentation space as described with respect to FIG. 5 for a title bar widget 604, a location bar widget 606, a menu bar widget 608, as well as other widgets typically supported by browsers (not shown). The browser window widget 602 as shown also includes a content widget 610 presenting presentable resource related to things to do in Manteo, N.C. provided by a resource provider having an associated location of Manteo, N.C. as represented by the map mark 614A and associated flyover text.

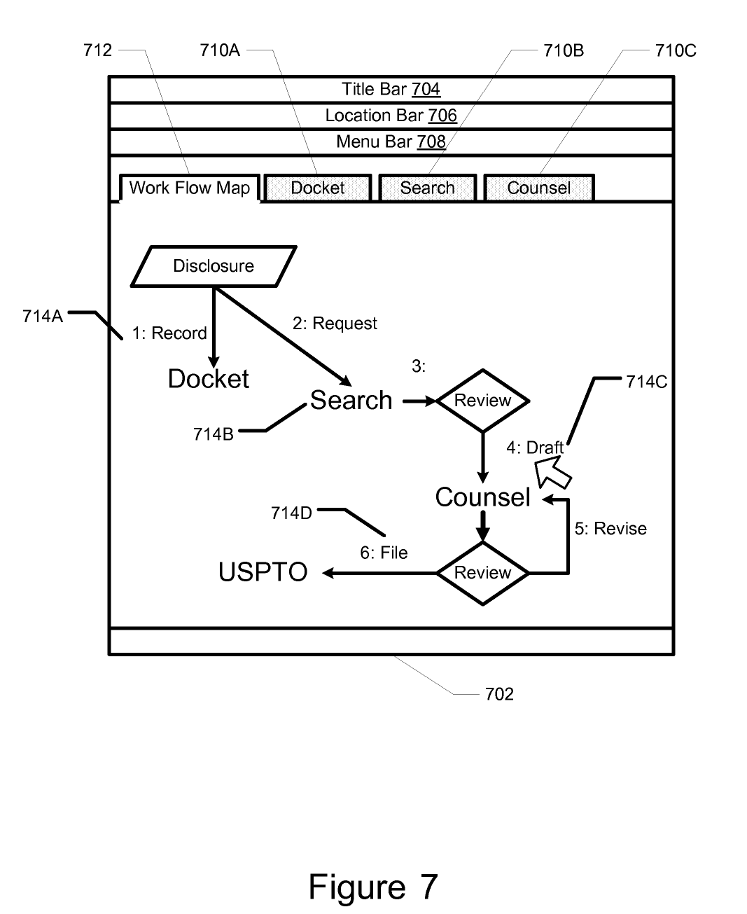

FIG. 7 depicts a further alternative user interface for the browser 306. The browser 306 can include a widget handler component 320 for a browser window widget 702. The browser window widget 702 can provide a presentation space as described with respect to FIG. 5 for a title bar widget 704, a location bar widget 706, a menu bar widget 708, as well as other widgets typically supported by browsers (not shown). The browser window widget 702 as shown also includes content widget 710A presenting a presentable resource from a resource provider for recording an invention disclosure in a docketing system, a content widget 710B presenting a presentable resource from a resource provider for requesting a prior art search associated with an invention disclosure, and a content widget 710C for presenting a presentable resource from a resource provider for submitting prior art search results and an invention disclosure to outside counsel for review and optionally drafting a patent application.

Returning to FIG. 1, in block 104 map information is received identifying a map associated with the presentable resource along with the first message including the presentable resource. Accordingly, a system for presenting a map in correspondence with presenting a received resource includes means for receiving map information identifying a map associated with the presentable resource along with the first message including the presentable resource. For example, as illustrated in FIG. 2, a map widget handler component 204 is configured to receive map information identifying a map associated with the presentable resource along with the first message including the presentable resource.

The map information identifies a map associated with the presentable resource. The map information can be received in a message with the message including the presentable resource or in a separate message. The message that includes the presentable resource may include at least a portion of the map information and/or the at least a portion of the map information can be included in a separate message.

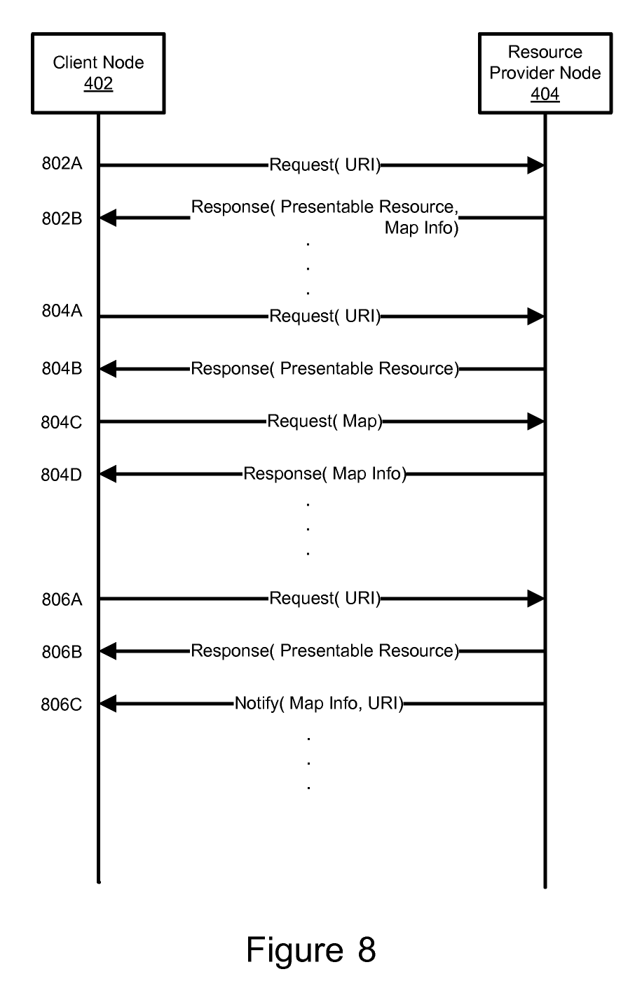

For example, exemplary message flows are depicted in FIG. 8. In a first example, the presentable resource can be requested in a request message 802A, such as an HTTP request, including a URI identifying the presentable resource. The request message 802A can be transmitted from the client node 402 to the resource provider node 404 as described above. The resource provider node 404 can transmit a response message 802B in response to processing the request message 802A. As depicted in FIG. 8, the response message 802B can include map information identifying a map associated with the presentable resource. The response message 802B may comprise one or more messages as previously described.

In a second example, a presentable resource can be requested by the client node 402 and a response can be transmitted from the resource provider node 404 as depicted by the request message 804A and the response message 804B analogous to the description above. The response message 804B does not include map information including a presentable representation of a map. The message 804B can include information allowing the navigation space handler component 206 to request an associated map as shown in a map request message 804C sent to the resource provider node 404. The map request message 804C may identify the presentable resource, the resource provider, the recipient, and/or the map. Additionally and/or alternatively, the map request message may include at least a portion of the presentable resource and an associated attribute of the resource provider, such as the presentable resource's URI. The resource provider can send a map response message 804D including map information for presenting a map associated with the received presentable resource.

As depicted in FIG. 2 and in FIG. 3, the content manager component 202 receiving the presentable resource can be configured to send the message 804C to the resource provider node 404 using a predetermined URI or portion of a URI. For example, the content manager component 202 can retrieve and/or include a path portion of a URL, such as “maps?resource=“%1”, where %1 represents a variable replaceable with a URI of a received presentable resource. The content manager component 202 can generate the request message 804C by appending the configured path portion with the variable replaced to a portion of the URI with which the presentable resource is accessed. Alternatively or additionally, the content manager component 202 can be configured with a URI of a map provider hosted by a map provider node (not shown). The content manager component 202 can transmit the message 804C to the configured map provider where the message identifies the presentable resource and/or an associated attribute, such as the presentable resource's URI.

Alternatively or additionally, the configured relative path and/or the URI of a map provider can be included in the message including the presentable resource such as the response message 804B.

Alternatively or additionally, the content manager component 202 can provide the received presentable resource to one or more content handler components 322 based on a MIME type of one or more portions 322 of the presentable resource. FIG. 3 depicts exemplary content handlers including a content handler component 322A for processing a presentable resource with a MIME type of text/html, a content handler component 322B for processing a presentable resource with a MIME type of application/xmpp-xml, a content handler component 322C for processing a presentable resource with a MIME type of video/mpeg, and a content handler component 322D for processing a presentable resource with a MIME type of image/jpeg. Any content handler component 322 can be configured to perform the operation of requesting map information described above with respect to the content manager component 202. A content handler component 322 can be configured to determine a source for map information associated with a presentable resource based on information in the presentable resource processed, such as detected metadata including a URI for requesting map information.

In a further alternative or additional option, at least a portion of a processed presentable resource message can be provided to the map widget handler component 204 for performing any of the operations described above for determining a source of map information associated with the received presentable resource. The presentable resource or a portion thereof can be provided to the map widget handler component 204 via a content widget handler component 208 interoperating with one or more content handler components 322.

In yet another alternative or additional option, the map widget handler component 204 can provide at least a portion of the presentable resource, such as location information provided in and/or along with the presentable resource. The location information can be provided to a map resolver component 324 for determining a network identifier of a map provider using any of the methods described in U.S. application Ser. Nos. 12/170,281, 12/170,829, 12/170,833, 12/328,038, and 12/328,055.

An association record for associating map information with a presentable resource can be stored in a map database component 326 as a cache for faster access to map information on a subsequent access for the associated presentable resource.

The messages 806A-806C in FIG. 8 illustrate another possible message flow pattern for receiving map information. The client node 402 can send a request message 806A including a URI of a presentable resource to the resource provider node 404 and in response receive a response message 806B providing access to the presentable resource to the client node 402. In response to at least one of receiving the request message 806A and sending the response message 806B, the resource provider can be configured to provide for sending an asynchronous message illustrated by the notify message 806C including map information associated with the presentable resource. In the notify message 806C a correlator, such as a URI identifying the presentable resource, can be included allowing the client node 202 to associate the notify message 806C with the presentable resource. The notify message 806C can be sent over the same connection, such as a TCP/IP connection as the request/response message pair 806A/806B to avoid being blocked by a firewall. Alternatively, the client can establish a separate connection such as subscription connection for receiving asynchronous messages through a firewall. In some cases, the resource provider node 404 can send an asynchronous message without firewall interference using a preconfigured port number using connection oriented and/or connectionless communications.

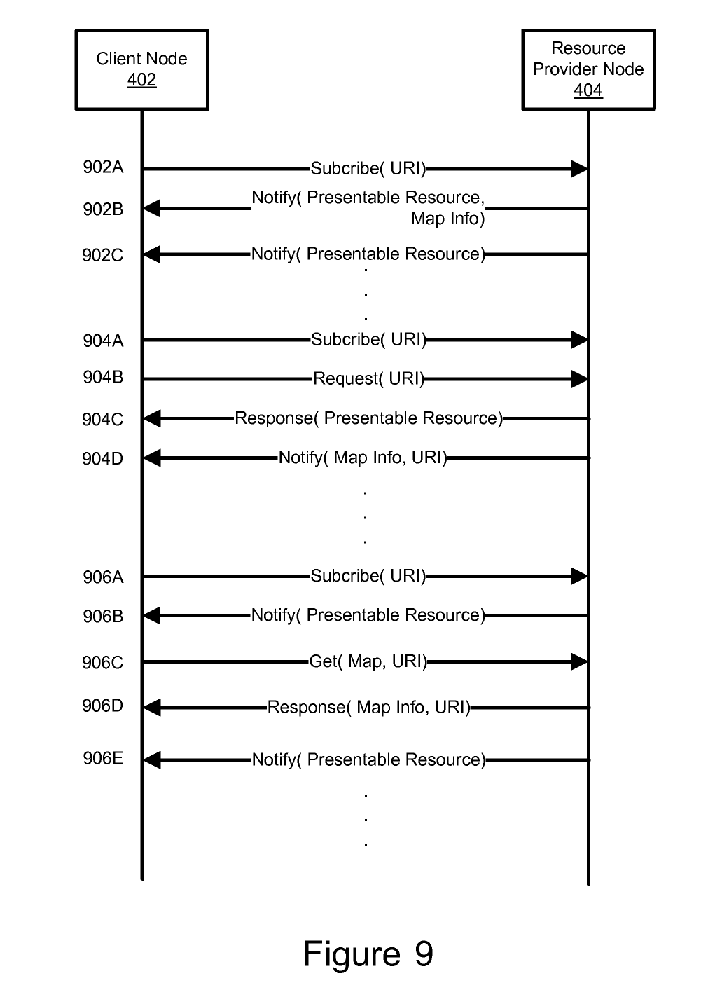

FIG. 9 includes three additional message flow variations. In the messages 902A-902C a presentable resource is accessed by the client node 402 via a subscribe message 902A including a URI of the presentable resource. The receiving resource provider node 404 can send one or more notify messages 902B, 902C, etc. that include at least a portion of a presentable resource identified by the URI. For example, the resource provider node 404 can send a notify message whenever the presentable resource is changed or otherwise updated. One or more of the notify messages 902B, 902C, etc. can include map information. In some cases map information is included in the first notify message 902A only as all versions of the presentable content can be associated with the same map. Alternatively, a change in the presentable content can be associated with a change in a map including replacing a map and/or updating a map. Still further, a notify can include only map information when a change to a map associated with a presentable resource is detected and there is no change in the presentable resource since a last version/portion of the presentable resource was sent from the resource provider node 404 to the client node 402.

In the message flow as illustrated by messages 904A-904D, the client node 402 sends a subscribe message identifying a presentable resource by including a URI of the resource for subscribing to map information. The client node 402 can also receive the presentable resource by requesting the resource as depicted by a request message 904B and a corresponding response message 904C. The map information associated with the presentable resource can be received via one or more notifications associated with the subscribe message 904A, such as the notify message 904D. The possible valid orders of the message 904A-904D are not limited to the order shown in FIG. 9.

The message flow pattern illustrated by the messages 906A-906E is analogous to the messages 904A-904D except that the presentable resource is requested via a subscribe message 906A and the presentable resource or portions thereof are received via one or more notifications associated with the subscribe message 906A, such as the notify message 906B, 906E, etc. The map information is retrieve by the client via a request message 906C for map information including an identifier of the presentable resource. The map information is provided in a response message 906D corresponding to the request message 906C.

Map information can include at least a portion of a map and can include a reference for accessing at least a portion of a map. A map can include and/or reference at least one of image data (still and video), drawing data (included animation), and display site navigation history on the map.

The map widget handler component 204 may determine if a current map being presented and/or in the map database 326 matches the map information. If no current map matches the map information, the map is retrieved.

Returning to FIG. 1, in block 106 location information is received identifying a location on the map corresponding to the presentable resource. Accordingly, a system for presenting a map in correspondence with presenting a received resource includes means for receiving location information identifying a location on the map corresponding to the presentable resource. For example, as illustrated in FIG. 2, a navigation space handler component 206 is configured to receive location information identifying a location on the map corresponding to the presentable resource. The location information identifies a location on the map that corresponds to the presentable resource.

For example, as depicted in FIG. 3 the navigation space handler component 206 can be provided with the presentable resource and/or the map information from the map widget handler component 204 and/or optionally via the content widget handler component 208. The location information can be included in and/or with the presentable resource. Alternatively or additionally, the location information can be provided in and/or with the map information.

The navigation space handler component 206 can be configured to determine the location information based on the presentable resource and/or map information. For example, the navigation space handler component 206 can be configured to invoke a map resolver component 324 to resolve a network identifier associated with the presentable resource, such as the network identifier of the resource provider, to a location. If the network identifier is an IP address or a domain name of the resource provider node 404, the map resolver component 324 can query a DNS server to retrieve location information stored in a LOC record associated with the IP address of the resource provider node 404. Further, the map resolver component 324 can be configured to determine a location as described in U.S. application Ser. No. 12/328,063 where the map resolver component 324 is configured to additionally perform the operations of a location resolver as described in U.S. application Ser. No. 12/328,063 and/or as described in U.S. application Ser. No. 12/328,036.

Still further, location information can be received as user input via the input subsystem 312 in correspondence with a portion of a user interface of the browser 306. Location information can be configured and stored in a database, such as the map database 326 for receiving by the navigation space handler component 206 in response to a lookup operation.

In one aspect, the navigation space handler component determines if a current location on the map matches a location of the resource provider of the presentable resource. The current location is used if the current location matches the location of the resource provider of the presentable resource.

Returning to FIG. 1, in block 108 the presentable resource is presented in a first presentation space of a browser. Accordingly, a system for presenting a map in correspondence with presenting a received resource includes means for presenting the presentable resource in a first presentation space of a browser. For example, as illustrated in FIG. 2, a content widget handler component 208 is configured to present the presentable resource in a first presentation space of a browser.

For example, as already described, the content widget handler component 208 can present the content widget 510 in a presentation space of the browser window widget 502. The content widget 510 and the corresponding content widget handler component 208 can be provided access to a first presentation space maintained by the GUI manager component 316 and/or the output subsystem 314. The content widget handler component 208 can present a presentable resource in the first presentation space. In FIG. 5, a web page from a resource provider of the Board of Governors of the Federal Reserve is presented in the first presentation space of the content widget 510 of the browser 306.

Analogously, the content widget handler component 208 of the browser 306 can present a presentable resource of a resource provider associated with Manteo, N.C. in a first presentation space of the content widget 610 included in a user interface of the browser 306 as illustrated in FIG. 6. FIG. 7 illustrates yet another example, of the content widget handler component 208 of the browser 306 presenting presentable resources of resource providers associated with an invention disclosure workflow in the content widgets 710 presenting presentable resources described above.

Returning to FIG. 1, in block 110, in correspondence with presenting the presentable resource, in a second presentation space of the browser the identified map including a visual representation of the presentable resource at the identified location on the map is presented. Accordingly, a system for presenting a map in correspondence with presenting a received resource includes means for presenting, in correspondence with presenting the presentable resource, in a second presentation space of the browser the identified map including a visual representation of the presentable resource at the identified location on the map. For example, as illustrated in FIG. 2, a map widget handler component 204 is configured to present, in correspondence with presenting the presentable resource, in a second presentation space of the browser the identified map including a visual representation of the presentable resource at the identified location on the map.

The presentation of the map is performed in correspondence with the presentation of the presentable resource. The map can be presented prior, during, and/or after the presenting of the presentable resource in a manner that corresponds the map with the presentable resource. Examples of corresponding presentations of the map and the presentable resource are described below. Further a visual representation of the presentable resource is included in the presentation of the identified map. The visual representation can include an icon, video, audio, text, and/or an animation representing the presentable resource. The map may be at least partially hidden behind the presentation of the presentable resource. Additionally, a map change indicator may be displayed in the browser 306, such as in the first presentation space when a change in the map occurs.

As depicted in FIG. 3 the map widget handler component 204 can receive the map information of the identified map from the navigation space handler component 206. The map can be represented visually via one or more resources including a still image, a video, an animation, text, audio, and/or a drawing. The map widget handler component 204 can interact with the presentation controller component 318, the GUI manager component 316, and/or other widget handler components 320 to present a visual representation of the map based on the map information in a second presentation provided with a map widget. The map widget and the second presentation space can be maintained by the GUI manager component 316 and/or the output subsystem 314 on behalf of the corresponding map widget handler component 204 as directed by the map widget handler component 204.

FIG. 5 depicts a map 512 of the United States for presenting visual representations 512 of a number of associated presentable resources provided by one or more resource providers. The map 512 is presented as a background for content widgets such as the content widget 510 displaying a presentable resource having a corresponding visual representation presented at a location on the map 512. The visual representations 514 represent locations of the Federal Reserve System. Visible in FIG. 5 is a visual representation 514A presented at a location corresponding to Washington, DC; a visual representation 514B presented at a location corresponding to Philadelphia, Pa.; a visual representation 514C presented at a location corresponding to Boston, Mass.; a visual representation 514D presented at a location corresponding to New York, N.Y.; a visual representation 514E presented at a location corresponding to Cleveland, Ohio; a visual representation 514F presented at a location corresponding to Richmond, Va.; and a visual representation 514G presented at a location corresponding to Atlanta, Ga. The locations correspond to the physical locations of various Federal Reserve Banks and the Federal Reserve headquarters in Washington, DC. The Washington, DC location is highlighted in FIG. 5 to indicate it corresponds to the presentable resource in the content widget 510 that currently has focus. The map information identifying the map 512 can be received along with the first presentable resource received that is associated with the map 512. Alternatively, the map information for the map 512 can be received with all the associated visual representations of associated presentable resources included and/or identified.

FIG. 6 depicts an historic map 612 of eastern North Carolina associated with a tour and presents visual representations 614 of a number of associated presentable resources provided by one or more resource providers. The map is presented in a map widget that slides in and out from under the associated content widget 610. The movement of the map widget can respond to user input and/or be automatic based on receiving an associated presentable resource, for example. The visual representations 614 represent cities with locations in eastern N.C. that have an attraction of historical significance as defined by the tour. Visible in FIG. 6 is a visual representation 614A presented at a location corresponding to Manteo, N.C.; a visual representation 614B presented at a location corresponding to Okracoke Island, N.C.; and a visual representation 614C presented at a location corresponding to Wilmington, N.C.

Manteo, N.C. is highlighted as it corresponds to the presentable resource in the content widget 510 that was just received and presented as indicated by the fly-over text associated with the visual representation 614A. The visual indications for Okracoke Island 614B and Wilmington 614C were presented when presentable resources associated with those locations were presented in a content widget in an aspect. The visual representations have been persisted to indicate what resources associated with points of historical interest have been received in the aspect. The content widget component 610 can be configured to present presentable resources associated with a subscription to one or more tuples of a resource provider providing tour information. The content widget component 610 can be updated by the content widget handler component 208 each time a notification message including presentable resource information is received. The notifications associated with the subscription cause various resources associated with points of historical interest to be dynamically displayed along with a visual representation presented along with an associated current presentable resource and visual representations of the presentable resource previously received. The subscription can be a presence subscription where the notifications identify a location visited by an associated principal. The map 612 can be received prior to receiving any associated presentable resource. A subscription for receiving notifications including presentable resources associated with the map can be established in response to receiving the map information for the map 612.

FIG. 7 depicts a map 712 of a work flow associated with an invention disclosure process. The map presents visual representations 714 of tasks completed, a current task, and a next task. Visible in FIG. 7 is a visual representation 714A presented at a location corresponding to a completed docketing task associated with receiving a new disclosure, a visual representation 714B presented at a location corresponding to a complete prior art search task, a visual representation 714C presented at a location corresponding to a current task associated with prior review and drafting of a patent application, and a visual representation 714D presented at a location corresponding to a next task of filing the patent application with the United States Patent and Trademark Office (USPTO). The locations correspond to the order of tasks in the work flow. In an aspect, when a new work flow is started, a visual representation of a presentable resource associated with a first task is presented as a next task in the map 712. An input can be received associated with the visual representation 714A for recording the received disclosure. A presentable resource, such as a form in a docketing system can be presented in the content widget 710A for performing the task. Along with receiving the form map information can be received confirming that the map 712 is associated with the presentable resource and a location for presenting a visual representation associated with a resource for performing a next task can be determined and the visual representation for the next task can be presented. The process can continue in this manner until ended or completed.

Types of maps that can be presented include, for example and not by way of limitation: Goode Homolosine projections; Mercercator projections; Gall's stereographic projections; Sinusoidal (Sanson-Flamsteed) projections; Mollweide projections; Hammer (Hammer-Aitoff) projections; Bartholomew's Nordic, Regional and ‘The Times’ projections; Orthographic projections; Equidistant projections; Lambert azimuthal equal-area projections; polar projections; Conic projections; and Bonne projections. Those skilled in the art will recognize that other types of maps can be presented.

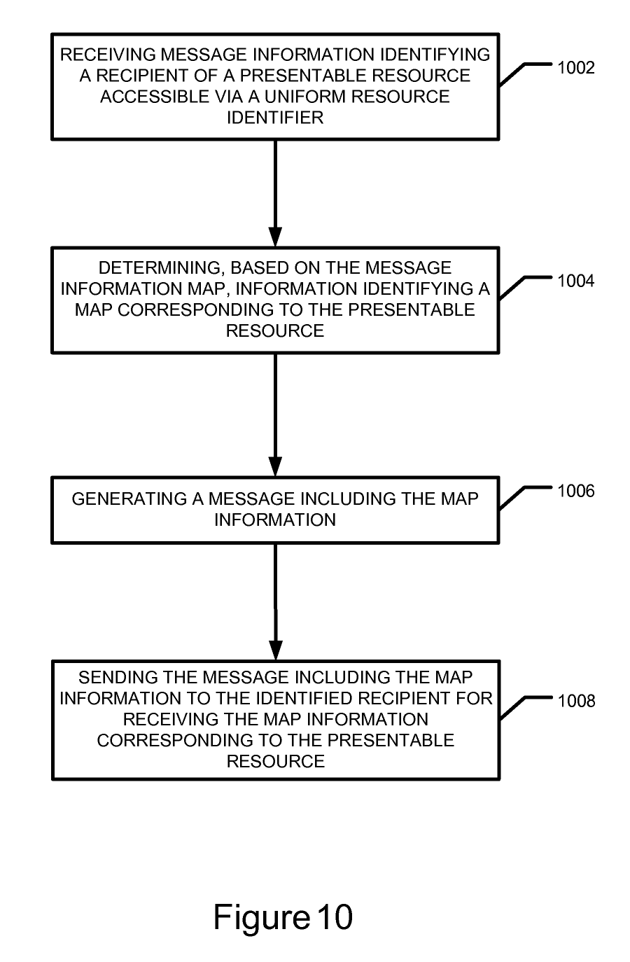

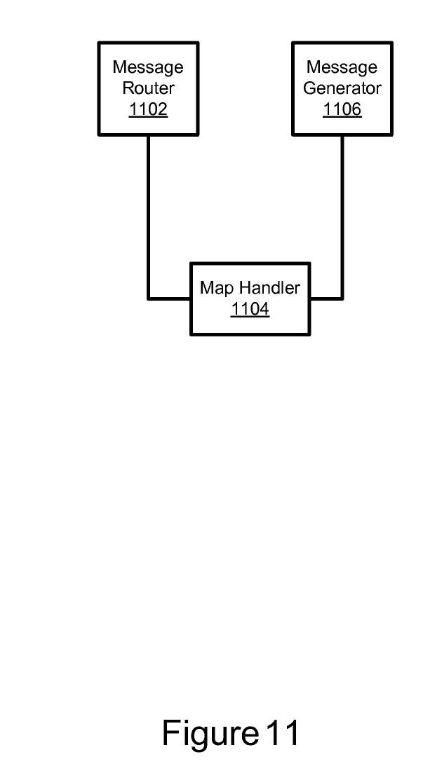

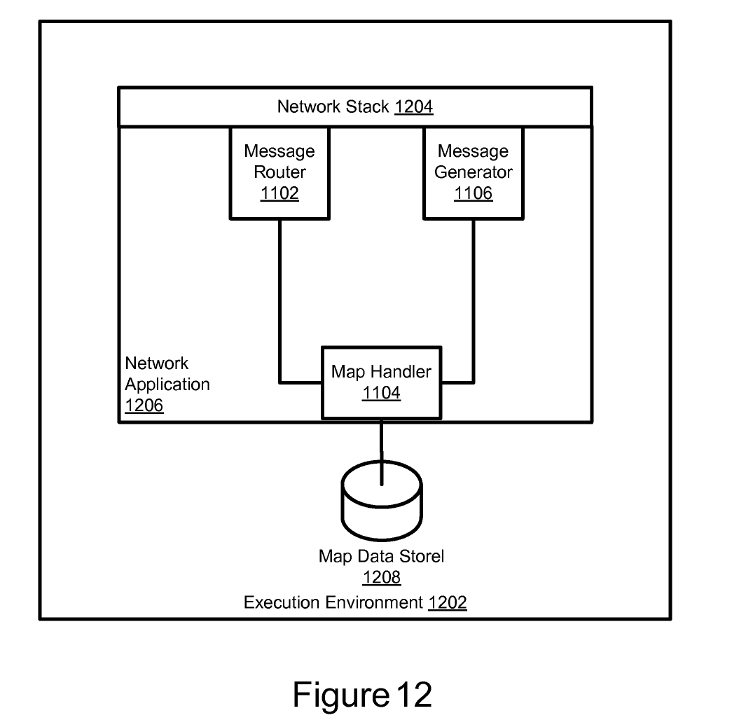

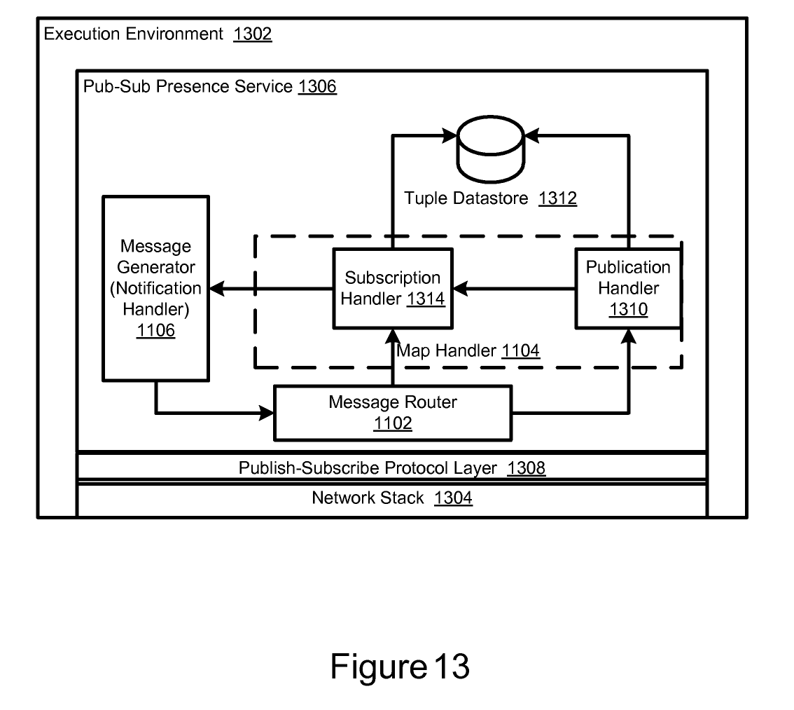

FIG. 10 is a flow diagram illustrating a method for providing a map for presenting in correspondence with a presented resource according to an exemplary aspect of the subject matter described herein. FIG. 11 is a block diagram illustrating a system for providing a map for presenting in correspondence with a presented resource according to another exemplary aspect of the subject matter described herein. FIGS. 12 and 13 are each a block diagram illustrating an arrangement of components providing an execution environment configured for hosting the arrangement of components depicted in FIG. 11. The method illustrated in FIG. 10 can be carried out by, for example, some or all of the components illustrated in the exemplary arrangement in FIG. 11 operating in an a compatible execution environment, such as the environment provided by some or all of the components of the arrangement in FIG. 12 and/or the FIG. 13.

With reference to FIG. 10, in block 1002 message information is received identifying a recipient of a presentable resource accessible via a uniform resource identifier (URI). Accordingly, a system for providing a map for presenting in correspondence with a presented resource includes means for receiving message information identifying a recipient of a presentable resource accessible via a uniform resource identifier (URI). For example, as illustrated in FIG. 11, a message router component 1102 is configured to receive message information identifying a recipient of a presentable resource accessible via a uniform resource identifier (URI). Note that identification of the recipient can be indirect, for example via a subscription associated with the recipient associated with the message as a publish message to a map info tuple.

The components depicted in FIG. 11 can be adapted for performing the method depicted in FIG. 10 in a number of execution environments, such as the exemplary execution environment 1202 depicted in FIG. 12 or the exemplary execution environment 1302 depicted in FIG. 13. Additionally or alternatively, an execution environment can be configured for hosting the components in FIG. 11 or analogous arrangements of components configured for performing the method in FIG. 10.

In FIG. 4, the resource provider node 404 can be configured to provide the execution environment 1202 or the execution environment 1302, each adapted for supporting the operation of the components in FIG. 11. As described above, an exemplary execution environment includes a memory for storing components and an instruction processing component, such as processor and/or a digital signal processor (DSP), for processing instructions and any data associated with the operation of the components such as the components in FIG. 11. The components in FIG. 11 and functionally analogous arrangements of components each can require additional hardware and/or software subsystems according to their particular operational requirements. For example, a network subsystem, such as the network subsystem 1204 in FIG. 12, can be included in the execution environment 1202 for communicating with a component in a remote device, such as the client node 402 over the network 406 as described above. An operating system, persistent data storage subsystem, memory management subsystem, and/or a process scheduler are other examples of components that can be required for various adaptations of the components in FIG. 11 and its functional analogs for performing the method in FIG. 10.

For example, as depicted in FIG. 12, the message router component 1102 operates in a network application 1206 configured to provide map information corresponding to a presentable resource. Additionally the network application 1206 can be configured to provide the presentable resource as well as the map information to an identified recipient (note that this alternative is not shown in FIG. 12). The message router component 1102 is configured to receive message information identifying a recipient and at least one of a resource provider of the presentable resource, a map information identifier, and an identifier of the presentable resource such as its URI. The received message can be received from a network, such as the network 406, via the network stack 1204 and/or can be received via a message from a component operating in the execution environment such as a resource provider component (not shown) in the node 404 and/or a client component in the node 402.

FIG. 13 is a second example depicting an adaption of the message router component 1102 operating in a in publish-subscribe service 1306. Additionally the publish-subscribe service 1306 can be configured to maintain tuples enabling access to one or more presentable resources as well as tuples for providing map information. The message router component 1102 can be configured to receive message information identifying a recipient and at least one of a resource provider of the presentable resource, a map information identifier, and an identifier of the presentable resource such as its URI. The message can be a publish message, for example, from a resource provider of a presentable resource. Alternatively or additionally, the message can be a subscribe message, for example for a recipient of a presentable resource. The received message can be received from a network, such as the network 406, via a network stack 1304 and a publish-subscribe protocol layer 1308.

Returning to FIG. 10, in block 1004 based on the message information, map information is determined identifying a map corresponding to the presentable resource. Accordingly, a system for providing a map for presenting in correspondence with a presented resource includes means for determining based on the message information map information identifying a map corresponding to the presentable resource. For example, as illustrated in FIG. 11, a map handler component 1104 is configured to determine based on the message information map information identifying a map corresponding to the presentable resource.

The map information can be identified based on at least one of an identified resource provider providing the presentable resource, identified map information, and the identified resource. One or more of the identifiers can be included in the received message information and/or can be determined based on the message information as is illustrated below.

For example, as depicted in FIG. 12 the message router component 1102 can provide the message information from the received message to the map handler component 1104. In the network application 1206 in FIG. 12 the recipient identification information can be determined based on source address information in the message when the message is from the recipient and/or included in another suitable form and/or location in the received message. The resource provider, map, and/or resource can be identified based on the message information. The map handler component 1104 can be configured to determine map information based on the identity of the resource provider alone.

Alternatively or additionally, the map information can be identified based on other attributes associated with the resource provider, recipient, and/or the presentable resource including location information, a task, and/or a user each associated with one or more of the resource provider, recipient, and/or presentable resource.

Alternatively or additionally, the received message can include information identifying the presentable resource such as its URI. The map information can be determined by the map handler component 1104 based on the resource identifier alone. As indicated above, the resource identifier can, alternatively or additionally, be used along with other attributes associated with the resource provider, recipient, and/or the presentable resource for identifying the map information by the map handler component 1104.

Analogously, as depicted in FIG. 13 the message router component 1102 can provide the message information from the received message to the map handler component 1104. The received message can be a publish message provided to a publication handler component 1310 included in the map handler component 1104 for updating a tuple in a tuple data store component 1312. The tuple can include map information associated with the resource provider, presentable resource, and/or the recipient. The publish message can identify the tuple through an association with the presentable resource, the recipient, and/or with the map information. The publish message can identify the recipient for indicating a directed notify message is to be sent to the recipient, as described below. The map information can be determined based on the tuple identified by the publish message.

Alternatively or additionally, the received message can be a subscribe message from the recipient provided to a subscription handler component 1314 included in the map handler component 1104. The subscribe message can identify one or more of the presentable resource, resource provider, and the map information for establishing subscription to the tuple including map information. The map information can be determined based on the tuple subscribed to by the subscribe command.

As in the arrangement of components in FIG. 12, the map information can be identified based on one or more of the identities of the recipient, the resource provider, the map, and/or the presentable resource. Alternatively or additionally, other attributes associated with the resource provider, recipient, map, and/or the presentable resource can be used in determining the map information by the map handler component 1104 operating in the publish-subscribe service 1306 as shown in FIG. 13.

In an example, a publish command can be received from a resource provider, such as a resource provider operating in the resource provider node 404, providing a presentable resource to an identified recipient, for example included in or used by the client node 402. The publish message can include tuple information associated with the resource provider as a principal including map information associated with the resource provider such as a map representing a location of the resource provider.

The publish message can include task information for a task tuple where the task or workflow including the task is the identified principal represented by the tuple. The tuple can include a task map. Alternatively or additionally, the publish message can include presentable resource information for a resource tuple where the resource is the represented principal. Alternatively or additionally, the resource tuple can include an element including map information. Alternatively or additionally, the publish message can include recipient information for a recipient tuple of the recipient of the presentable resource.

Returning to FIG. 10, in block 1006 a message is generated including the map information. Accordingly, a system for providing a map for presenting in correspondence with a presented resource includes means for generating a message including the map information. For example, as illustrated in FIG. 11, a message generator component 1106 is configured to generate a message including the map information.

As depicted in FIG. 12 the message generator component 1106 can be configured to receive the map information from the map handler component 1104. The message generator component 1106 can generate a response message for responding to the message information received in a request message from the recipient.

In FIG. 13 the message generator component 1106 can be configured to operate as a notification handler of the publish-subscribe service 1306. When a publish message includes an identifier of the recipient of the presentable resource, the publication handler component 1310 can provide the recipient identifier to the subscription handler component 1314 for invoking the message generator component 1106 or can provide the published information included in the publish message and the recipient identifier to the message generator component 1106 directly. The tuple information provided to the message generator component 1106 includes the map information included in the tuple information of the tuple identified in the publish message. The message generator component 1106 can generate a directed notify message. With a directed notify message the recipient need not have a subscription to the tuple identified in the publish message in order to receive the notify message.

Alternatively, as described above, the recipient can be identified by a subscription established for the recipient by the subscription handler component 1314 to the tuple identified in the publish message. Alternatively, the subscription can be established on behalf of the recipient based on receiving recipient information from the resource provider. The subscription can be established for the recipient of the presentable resource in response to a received subscribe message including message information identifying the recipient as a subscriber.

Returning to FIG. 10, in block 1008 the generated message including the map information is sent to the identified recipient for receiving the map information corresponding to the presentable resource. Accordingly, a system for providing a map for presenting in correspondence with a presented resource includes means for sending the generated message including the map information to the identified recipient for receiving the map information corresponding to the presentable resource. For example, as illustrated in FIG. 11, a message generator component 1106 is configured to send the generated message including the map information to the identified recipient for receiving the map information corresponding to the presentable resource. In one aspect, the presentable resource is also provided to the identified recipient.

As depicted in FIG. 12 the message generator component 1106 can send the generated message including the map information as a response message to a request message including message information identifying the recipient to the recipient. The response message can be sent via the network stack 1204 operatively coupled to a network, such as the network 406 including a node of the recipient, such as the client node 402.

In FIG. 13, the message generator component 1106 can provide to the message router component 1102 a notify message including a tuple having the map information as a directed notify or as a notify message associated with a subscription established for the recipient. The message router component 1102 interoperates with the publish-subscribe protocol layer 1308 to send the notify message in a publish-subscribe protocol format compatible with the receiving client node 402 of the recipient. The publish-subscribe protocol layer 1304 transmits the message to the client node 402 via the network stack 1304 as described above.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for presenting a map in correspondence with presenting a received resource, the method comprising:
receiving from a resource provider a first message including a presentable resource accessible via an uniform resource identifier (URI);
receiving map information identifying a map associated with the presentable resource along with the first message including the presentable resource;
receiving location information identifying a location on the map corresponding to the presentable resource;
presenting the presentable resource in a first presentation space of a browser; and
presenting, in correspondence with presenting the presentable resource, in a second presentation space of the browser the identified map including a visual representation of the presentable resource at the identified location on the map,
wherein at least one of the preceding actions is performed on at least one electronic hardware component.

2. The method of claim 1 wherein receiving the map information comprises receiving the map information in at least one of the first message and a second message.

3. The method of claim 2 wherein the first message and the second message are received in response to requesting the presentable resource using the URI.

4. The method of claim 2 wherein the first message includes information allowing the map information to be requested, and wherein receiving the map information in the second message comprises receiving the map information in the second message in response to requesting map information based on the information in the first message.

5. The method of claim 4 wherein requesting the map information comprises sending a request message identifying at least one of the presentable resource, the resource provider, the recipient, and the map.

6. The method of claim 5 wherein requesting the map information comprises sending a request message including a URI identifying the presentable resource.

7. The method of claim 2 wherein receiving the second message comprises receiving the second message asynchronously.

8. The method of claim 1 further comprising determining a source for the map information based on information in the presentable resource.

9. The method of claim 8 wherein the information in the presentable resource comprises metadata including a URI for requesting the map information.

10. The method of claim 1 wherein the map information includes location information for obtaining the map, the method further comprising determining a network identifier of a map provider.

11. The method of claim 1 wherein receiving the first message comprises receiving the first message via a subscribe message.

12. The method of claim 1 wherein receiving the first message comprises receiving at least one notify message containing at least a portion of the presentable resource identified by the URI.

13. The method of claim 1 comprising:
determining if a current map matches the map information; and
retrieving the map if the current map does not match the map information.

14. The method of claim 1 wherein the location information is included with the presentable resource.

15. The method of claim 1 comprising:
determining if a current location matches a location of the resource provider of the presentable resource; and
using the current location if the current location matches the location of the resource provider of the presentable resource.

16. The method of claim 1 wherein the presentable representations includes a visual representation that includes at least one of an icon, a video, an audio, text, and an animation representing the presentable resource.

17. The method of claim 1 wherein the identified map is at least partially hidden behind the presentation of the presentable resource.

18. The method of claim 16 further comprising displaying a map change indicator in the browser when a change in the map occurs.

19. A method for providing a map for presenting in correspondence with a presented resource, the method comprising:
receiving message information identifying a recipient of a presentable resource accessible via a uniform resource identifier (URI);
determining, based on the message information, map information identifying a map corresponding to the presentable resource;
generating a message including the map information; and
sending the generated message including the map information to the identified recipient for receiving the map information corresponding to the presentable resource,
wherein at least one of the preceding actions is performed on at least one electronic hardware component.

20. The method of claim 19 further comprising providing the presentable resource to the identified recipient.

21. The method of claim 19 further comprising receiving information identifying at least one of a resource provider of the presentable resource, a map, and the presentable resource.

22. The method of claim 19 wherein receiving message information comprises receiving message information via a publish message from a resource provider of the presentable resource.

23. The method of claim 19 wherein sending the generated message comprises sending a notify message to the identified recipient, the notify message including a tuple having the map information.

24. The method of claim 19 wherein determining the map information comprises determining the map information based on the identity of a resource provider providing the presentable resource.

25. The method of claim 19 wherein determining the map information comprises determining the map information based on the URI.

26. The method of claim 19 wherein determining the map information comprises determining the map information based on at least one attribute associated with a resource provider of the presentable resource, the recipient, and the presentable resource.

27. The method of claim 26 wherein the at least one attribute includes at least one of location information, a task, and a user associated with one or more of the resource provider, the recipient, and the presentable resource.

28. A system for presenting a map in correspondence with presenting a received resource, the system comprising:
means for receiving from a resource provider a first message including a presentable resource accessible via a uniform resource identifier (URI);
means for receiving map information identifying a map associated with the presentable resource along with the first message including the presentable resource;
means for receiving location information identifying a location on the map corresponding to the presentable resource;
means for presenting the presentable resource in a first presentation space of a browser; and
means for presenting, in correspondence with presenting the presentable resource, in a second presentation space of the browser the identified map including a visual representation of the presentable resource at the identified location on the map,
wherein at least one of the means includes at least one electronic hardware component.

29. A system for presenting a map in correspondence with presenting a received resource, the system comprising system components including:
a content manager component configured to receive from a resource provider a first message including a presentable resource accessible via a uniform resource identifier (URI);
a map widget handler component configured to receive map information identifying a map associated with the presentable resource along with the first message including the presentable resource;
a navigation space handler component configured to receive location information identifying a location on the map corresponding to the presentable resource; and
a content widget handler component configured to present the presentable resource in a first presentation space of a browser, the map widget handler component configured to present, in correspondence with presenting the presentable resource, in a second presentation space of the browser the identified map including a visual representation of the presentable resource at the identified location on the map,
wherein at least one of the system components includes at least one electronic hardware component.

30. The system of claim 29 wherein the navigation space handler component is further configured to request the map information.

31. The system of claim 30 wherein requesting the map information comprises sending a request message including at least a portion of the presentable resource and an associated attribute of the presentable resource.

32. The system of claim 30 wherein requesting the map information comprises sending a request message including the associated attribute, the associated attribute comprising a URI of the presentable resource.

33. The system of claim 29 further comprising a content handler component configured to determine a source for the map information based on information in the presentable resource.

34. The system of claim 33 wherein the information in the presentable resource comprises metadata including a URI for requesting the map information.

35. The system of claim 29 wherein the map widget handler component is configured to receive the map information in a second message asynchronously.

36. The system of claim 29 wherein the content manager component is configured to receive the first message via at least one of a subscribe message and at least one notify message containing at least a portion of the presentable resource identified by the URI.

37. The system of claim 29 wherein the map widget handler determines if a current map matches the map information and retrieves the map if the current map does not match the map information.

38. The system of claim 29 wherein the navigation space handler component is configured to determine the location information based on at least one of the presentable resource and the map information.

39. The system of claim 29 wherein the navigation space handler component is further configured to:
determine if a current location matches a location of the resource provider of the presentable resource; and
use the current location if the current location matches the location of the resource provider of the presentable resource.

40. A system for providing a map for presenting in correspondence with a presented resource, the system comprising:
means for receiving message information identifying a recipient of a presentable resource accessible via a uniform resource identifier (URI);
means for determining based on the message information map information identifying a map corresponding to the presentable resource;
means for generating a message including the map information; and
means for sending the generated message including the map information to the identified recipient for receiving the map information corresponding to the presentable resource.

41. A system for providing a map for presenting in correspondence with a presented resource, the system comprising system components including:
a message router component configured to receive message information identifying a recipient of a presentable resource accessible via a uniform resource identifier (URI);
a map handler component configured to determine based on the message information map information identifying a map corresponding to the presentable resource; and
a message generator component configured to generate a message including the map information, the message generator component further configured to send the generated message including the map information to the identified recipient for receiving the map information corresponding to the presentable resource,
wherein at least one of the system components includes at least one electronic hardware component.

42. The system of claim 41 further comprising a network application configured to provide the presentable resource to the identified recipient.

43. The system of claim 41 wherein the message router component is further configured to receive information identifying at least one of a resource provider of the presentable resource, a map information identifier, and an identifier of the presentable resource.

44. The system of claim 41 wherein the message router component is configured to receive message information via a publish message from a resource provider of the presentable resource.

45. The system of claim 41 wherein the message generator component is configured to send the message by sending a subscribe message to the identified recipient, the subscribe message including a tuple having the map information.

46. The system of claim 41 wherein the map handler component is configured to determine the map information based on the identity of a resource provider providing the presentable resource.

47. The system of claim 41 wherein the map handler component is configured to determine the map information based on the URI.

48. The system of claim 41 wherein the map handler component is configured to determine the map information based on at least one attribute associated with a resource provider of the presentable resource, the recipient, and the presentable resource.

49. The system of claim 48 wherein the at least one attribute includes at least one of location information, a task, and a user associated with one or more of the resource provider, the recipient, and the presentable resource.

50. The system of claim 41 wherein the message router component receives the message information in a publish message and provides the publish message to a publication handler component for updating at least one tuple in a tuple data base, the at least one tuple including map information associated with at least one of a resource provider of the presentable resource, the presentable resource, and the recipient.

51. A computer readable medium embodying a computer program, executable by a machine, for presenting a map in correspondence with presenting a received resource, the computer program comprising executable instructions for:
receiving from a resource provider a first message including a presentable resource accessible via a uniform resource identifier (URI);
receiving map information identifying a map associated with the presentable resource along with the first message including the presentable resource;
receiving location information identifying a location on the map corresponding to the presentable resource;
presenting the presentable resource in a first presentation space of a browser; and
presenting, in correspondence with presenting the presentable resource, in a second presentation space of the browser the identified map including a visual representation of the presentable resource at the identified location on the map.

52. A computer readable medium embodying a computer program, executable by a machine, for providing a map for presenting in correspondence with a presented resource, the computer program comprising executable instructions for:
receiving message information identifying a recipient of a presentable resource accessible via a uniform resource identifier (URI);
determining based on the message information map information identifying a map corresponding to the presentable resource;
generating a message including the map information; and
sending the generated message including the map information to the identified recipient for receiving the map information corresponding to the presentable resource.
